(19) United States
(12) Patent Application Publication
(10) Pub. No.: US 2025/0109045 A1
(43) Pub. Date: Apr. 3, 2025

(54) MOBILE INJECTION UNIT BASED EFFLUENT TREATMENT DEVICE AND SYSTEM

(71) Applicants: QUADSUN SOLAR PRIVATE LIMITED, Gurgaon (IN); Aquality Solutions, LLC, Frisco, TX (US)

(72) Inventors: Prakash BHALEKAR, Gurgaon (IN); Shikhar PAL, Kanpur (IN)

(21) Appl. No.: 18/901,034

(22) Filed: Sep. 30, 2024

(30) Foreign Application Priority Data
Sep. 29, 2023 (IN) 202311065700

(51) Int. Cl. C02F 1/04

(52) U.S. Cl. CPC C02F 1/043; C02F 2201/008

(57) ABSTRACT

The present invention provides a mobile injection unit based effluent treatment system (100), comprising a first tank (200) for storing an effluent liquid, an injection unit (300), an evaporator unit (400), a condenser unit (500); and a second tank (600) for receiving a treated water. The injection unit (300) is for injecting a controlled amount of effluent liquid onto a plurality of pans (401). The evaporator unit (400) is configured to heat the effluent present in the plurality of pans (401) that results in formation of vapor leaving behind a residue. The condenser unit (500) receives the vapor from the evaporator unit (400) and condenses the vapor into the treated water.

### FIELD OF THE INVENTION

The present invention relates to an effluent treatment device and system. More particularly, the present invention relates to a mobile injection unit based effluent treatment device and system, which ensures uniform injection and optimal distribution of effluent liquid on the pans.

### BACKGROUND OF THE INVENTION

Effluent liquid refers to any liquid waste or discharge that is produced as a result of industrial, commercial or domestic activities. Effluent liquid typically refers to wastewater or sewage that is generated by various processes or operations, such as manufacturing, agriculture or household activities. The effluent liquid contains pollutants, contaminants or other substances that require treatment before being released into the environment to minimize potential harm to ecosystems and human health. An effluent treatment process aims to remove or reduce the pollutants and ensure that the discharged water meets regulatory standards and is safely reintroduced into the environment. The effluent treatment plays a crucial role in safeguarding water resources and maintaining ecological balance.

Further, effluent treatment system encompasses a range of technologies introduced to treat and manage wastewater effectively. Physical treatment systems such as screening and sedimentation, remove large solids and allow suspended particles to settle respectively. Chemical treatment methods involve the use of coagulants and flocculants to facilitate the aggregation and removal of fine particles. Biological treatment processes, such as activated sludge and bio filtration, employ microorganisms to break down organic contaminants. Advanced treatment systems like membrane filtration, ultraviolet disinfection, and ozonation provide further purification and disinfection.

Another type of effluent treatment system is an evaporator-based effluent liquid treatment which is a process that utilizes an evaporator to remove water or other solvents from wastewater or liquid effluent streams. This treatment method is particularly effective in reducing the volume of liquid waste and concentrating any dissolved solids or contaminants present in the effluent.

In an evaporator-based treatment system, the effluent is introduced into the evaporator vessel. Heat is applied to raise the temperature of the liquid, causing the water or solvent to evaporate. The evaporated water or solvent vapor is then condensed and collected separately, leaving behind a concentrated liquid residue.

The concentrated liquid residue typically contains higher concentrations of dissolved solids, pollutants or contaminants that were present in the original effluent. Depending on the specific requirements, this concentrated residue undergoes further treatment, disposal, or reuse.

Evaporator-based effluent liquid treatment offers advantages such as volume reduction, effective removal of water or solvents and potential recovery of valuable substances from the concentrated residue. However, evaporator-based effluent liquid treatment is important to consider the nature of the effluent and any specific regulatory requirements to ensure the proper treatment and management of the concentrated residue.

U.S. Pat. No. 8,372,274B2 describes water supply treatment systems, including a wastewater treatment system and method for removing various contaminants from wastewater generated in various settings. While the invention addresses the removal of biodegradable fats, oil, grease, solids, organic contaminants, nutrients, pathogens, and similar substances from wastewater, but it lacks an efficient distribution mechanism for the effluent liquid onto the pans.

CN205676258U describes an effluent treatment plant that encompasses several components including a sewage inlet, expansion chamber, electromagnetic valves and screen plate, dirt receiving room, drainage screen and outlet of sewer. The sewage inlet is connected to the expansion chamber with a pipeline extending from the lower rear end of the sewage inlet to the dirt receiving room. An electromagnetic valve is positioned at the front end of the pipeline, while a screen plate is placed at the rear end. The upper rear end of the sewage inlet is linked to a curvilinear structure featuring an electromagnetic valve at its front end. The curvilinear structure is connected to both the outlet of sewer and the dirt receiving room. Additionally, a drainage screen is installed at the front end of the outlet of sewer.

The efficient distribution of effluent liquid onto the pans is a crucial aspect of effluent treatment systems, particularly when dealing with large-scale industrial or commercial operations. Uneven or inadequate distribution leads to uneven treatment, incomplete removal of contaminants and compromised overall treatment efficiency. The absence of an efficient distribution feature results in inconsistent treatment results, increased processing time and potential inefficiencies in achieving the desired treatment objectives. It also limits the effectiveness of the system in handling specific effluent compositions or meeting stringent regulatory requirements.

Additionally, when the effluent liquid is poured into the pans, it tends to splash due to an impact of the liquid striking the surface of the pan due to lack in optimized structure to regulate liquid dynamics. The splashing of the effluent liquid negatively impacts the efficiency of the treatment process and creates an additional operational challenges.

Therefore, due to aforementioned issues, there is a need to provide an improved effluent treatment system and device for increasing the efficiency of the effluent treatment process.

### OBJECT OF THE INVENTION

The main object of the present invention is to provide a mobile injection unit-based effluent treatment device and system that overcomes the limitations of the prior art.

Another object of the present invention is to provide a mobile injection unit-based effluent treatment device and system that ensures efficient and controlled distribution of effluent liquid onto the pans, thereby improving treatment effectiveness.

Yet another object of the present invention is to provide a mobile injection unit-based effluent treatment device and system that offers versatility and adaptability to different effluent compositions, treatment requirements and industrial or commercial settings.

Yet another object of the present invention is to provide an improved pan for the mobile injection unit-based effluent treatment device and system that minimizes the splashing of the effluent liquid and eliminates the requirement of external attachment components for connecting the stack of pans.

Still another object of the present invention is to provide a mobile injection unit-based effluent treatment device and system that optimizes the use of resources, reduces processing time and enhances overall treatment efficiency.

### SUMMARY OF THE INVENTION

The present invention relates to an effluent treatment device and system having a mobile injection unit that includes features like controlled distribution, adjustable injection quantity and easy maintenance that further contributes to enhanced treatment effectiveness, improved efficiency and adaptability to various effluent compositions and treatment scenarios.

In an embodiment, the present invention provides a mobile injection unit based effluent treatment system. The system comprises a first tank for storing an effluent liquid, an injection unit, an evaporator unit, a condenser unit and a second tank for receiving a treated water. The injection unit includes two injecting pipes conjoined to a common effluent input and assembled with a sliding arrangement and fitted over a frame of evaporator unit with each injecting pipe having a plurality of nozzles assembled over the length for injecting a controlled amount of effluent liquid onto a plurality of pans. The evaporator unit houses the plurality of pans arranged over each other to receive the controlled amount of effluent liquid and said evaporator unit includes a plurality of pan end support structures with a strip of brush fitted on outer surface of each pan end support structure for cleaning the plurality of nozzles of the injecting pipes. The evaporator unit includes a fan assembly for providing a direct and balanced airflow onto the plurality of pans for spreading the effluent liquid uniformly and said evaporator unit is configured to heat the effluent present in the plurality of pans that results in formation of vapor leaving behind a residue. The plurality of pans have a base layer, a rib structure, a set of extended grooves through which the plurality of pans are arranged over each other in both horizontal direction and vertical direction and the rib structure on the base layer ensures uniform distribution of the effluent liquid and also reduces splashing of the effluent liquid. The condenser unit receives the vapor from the evaporator unit and condenses the vapor into the treated water.

The above objects and advantages of the present invention will become apparent from the hereinafter set forth brief description of the drawings, detailed description of the invention, and claims appended herewith.

### BRIEF DESCRIPTION OF THE DRAWING

An understanding of the mobile injection unit based effluent treatment system of the present invention may be obtained by reference to the following drawing:

FIG. 1 is a block diagram of the mobile injection unit based effluent treatment system according to an embodiment of the present invention.

FIG. 2 is a top view of the mobile injection unit according to an embodiment of the present invention.

FIG. 3 is a side view of the mobile injection unit according to an embodiment of the present invention.

FIG. 4 is a perspective view of the mobile injection unit according to an embodiment of the present invention.

FIG. 5 is a perspective view of the evaporator unit of the mobile injection unit based effluent treatment system according to an embodiment of the present invention.

FIG. 6(a) is another perspective view of the evaporator unit of the mobile injection unit based effluent treatment system according to another embodiment of the present invention.

FIG. 6(b) is a sectional view of the evaporator unit of the mobile injection unit based effluent treatment system according to another embodiment of the present invention.

FIG. 7 is a perspective view of the evaporator unit of the mobile injection unit based effluent treatment system according to another embodiment of the present invention.

FIG. 8 is a front view of the evaporator unit of the mobile injection unit based effluent treatment system according to another embodiment of the present invention.

FIG. 9 is a perspective view of a pan of the mobile injection unit based effluent treatment system according to an embodiment of the present invention.

FIG. 10 is a top view of a pan of the mobile injection unit based effluent treatment system according to an embodiment of the present invention.

FIG. 11 is a schematic view of a pan of the mobile injection unit based effluent treatment system according to an embodiment of the present invention.

FIG. 12 is a side view of a pan of the mobile injection unit based effluent treatment system according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a mobile injection unit-based effluent treatment device and system that ensures efficient distribution of the effluent liquid onto the pan, by employing a mobile injection unit, the device and system enables precise and controlled distribution of the effluent across the entire surface area of the pans addressing the limitations of existing systems.

In an embodiment, the present invention provides a mobile injection unit based effluent treatment system. The system comprises a first tank for storing an effluent liquid, an injection unit, an evaporator unit, a condenser unit and a second tank for receiving a treated water. The injection unit includes two injecting pipes conjoined to a common effluent input and assembled with a sliding arrangement and fitted over a frame of evaporator unit with each injecting pipe having a plurality of nozzles assembled over the length for injecting a controlled amount of effluent liquid onto a plurality of pans. The evaporator unit houses the plurality of pans arranged over each other to receive the controlled amount of effluent liquid and said evaporator unit includes a plurality of pan end support structures with a strip of brush fitted on outer surface of each pan end support structure for cleaning the plurality of nozzles of the injecting pipes. The evaporator unit includes a fan assembly for providing a direct and balanced airflow onto the plurality of pans for spreading the effluent liquid uniformly and said evaporator unit is configured to heat the effluent present in the plurality of pans that results in formation of vapor leaving behind a residue. The plurality of pans have a base layer, a rib structure, a set of extended grooves through which the plurality of pans are arranged over each other in both horizontal direction and vertical direction and the rib structure on the base layer ensures uniform distribution of the effluent liquid and also reduces splashing of the effluent liquid. The condenser unit receives the vapor from the evaporator unit and condenses the vapor into the treated water.

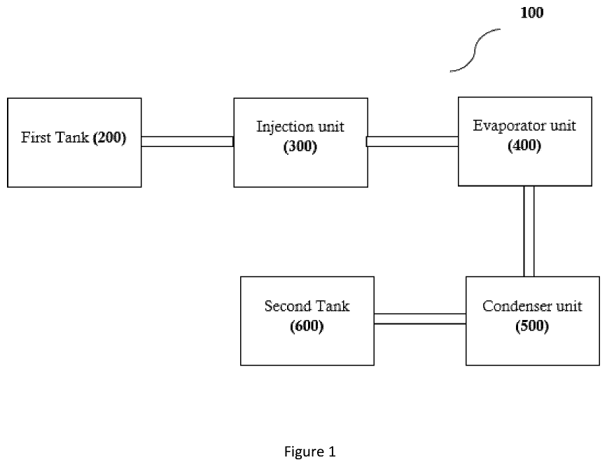

FIG. 1 is a block diagram of the mobile injection unit based effluent treatment system (100) according to an embodiment of the present invention. The system comprises a first tank (200) for storing an effluent liquid, an injection unit (300), an evaporator unit (400), a condenser unit (500), a second tank (600) for receiving a treated water.

In an implementation the injection unit (300) is a mobile injection unit that provides a controlled amount of effluent onto a plurality of pans (401) which are assembled in the evaporator unit (400). The controlled amount is set up by an operator of the system, for example, 1.5 L or 1 L. The injection unit (300) works in a precise manner to ensure that the system operates efficiently and the injection assembly deliver the exact quantity of effluent which is requires to achieve an optimal evaporation and performance of the system.

The injection unit (300) withdraws the effluent from the first tank (200) via a pump and pipe assembly. The first tank (200) stores a pre-defined amount of effluent such as 10 L or 20 L. The injection unit (300) include a pump that is configured for precise control over the dispensing of the effluent liquid onto the plurality of pans (401). Also, the common effluent input (305) is a T pipe connector further connecting the injecting pipes (303) through a pair of elbow connector (306).

The injection unit (300) is configured to dispense the effluent onto the plurality of pans (401) according to the air flow profile. The air flow profile refers to a specific pattern or manner in which the air flows over the plurality of pans (401). The injection unit (300) operates in sync with the air flow pattern for ensuring that the effluent is distributed properly across the plurality of pans (401).

The injection unit (300) moves along with faces of the plurality of pans (401) for ensuring a uniform distribution of the effluent across the surface of the plurality of pans (401). In other words, the injection unit (300) is not stationary and moves along with the surfaces or faces of the plurality of pans (401) and this movement ensures that the effluent is spread evenly across surface of each pan (401). The movement of the injection unit (300) avoid any area where the effluent is highly concentrated or spare.

The injection unit (300) is additionally connected with a docking station and the docking station is configured to clean the plurality of nozzles.

The evaporator unit (400) is configured to evaporate the effluent liquid that is present in the plurality of pans, thereafter the condenser unit (500) receives the vapor from the evaporator unit (400) and condenses the vapor into the treated water. The second tank (600) receives the treated water from the condenser unit (500). The second tank (600) collects and stores the liquid treated water until the liquid treated water is ready for discharge or reuse.

Also, the mobile injection unit based effluent treatment system (100) is remotely controlled via a controller module for optimizing the evaporation of the effluent liquid. The controller module is configured to optimize the evaporation rate of the effluent liquid by processing one or more parameters such as temperature, humid level, and pressure via one or more techniques such as machine learning technique or artificial intelligence techniques.

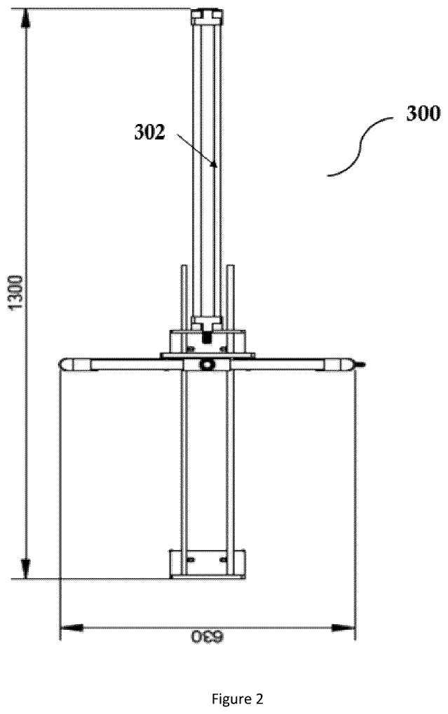

FIG. 2 is a top view of the mobile injection unit based effluent treatment system (100) according to an embodiment of the present invention. The injection unit (300) is a mobile injection unit that moves preferably in horizontal direction via a sliding arrangement (302). In an implementation, the sliding arrangement (302) includes a plurality of shafts that facilities in the movement of the injection unit (300). The plurality of shafts provides support to the injection unit (300). In another implementation, the sliding arrangement (302) is guided by a set of rails or a track assembly that ensures the horizontal movement of the injection unit (300) without tilting or wobbling. In another implementation, the sliding arrangement (302) extends or retract based on the operational requirements. Also, the sliding arrangement (302) is powered by a motorized actuator or a hydraulic actuator.

Also, the sliding arrangement (302) of the present invention is not limited to any specific configuration or structure and may include but not restricted to telescopic arrangement, guide rails, hydraulic or pneumatic arrangements, motorized actuators or any other mechanism that enables smooth and controlled movement of the injection unit (300) or associated component.

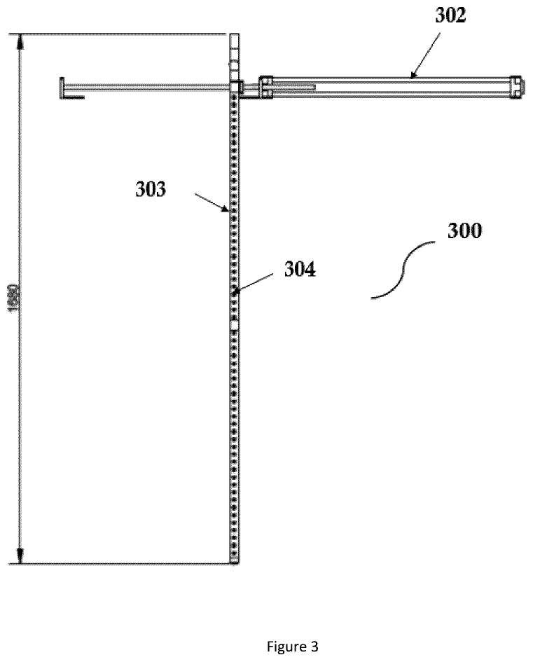

FIG. 3 is a side view of the mobile injection unit based effluent treatment system (100) according to an embodiment of the present invention. The injection unit (300) includes two injecting pipes (303) that are conjoined to a common effluent input (305) which is a T shaped connector. This configuration allows for efficient and simultaneous handling of the effluent liquid through both the injecting pipes (303).

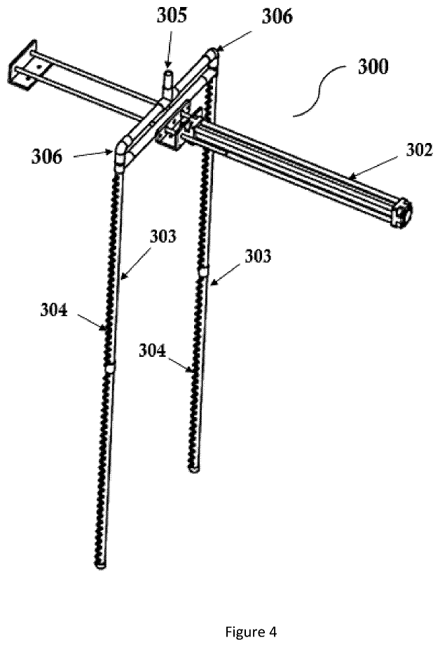

FIG. 4 is a perspective view of the mobile injection unit based effluent treatment system (100) according to an embodiment of the present invention. The injecting pipes (303) are connected to common effluent input (305) through a pair of elbow connector (306). The injecting pipes (303) are further assembled with the sliding arrangement (302) and fitted over a frame of evaporator unit (400) with each injecting pipe (303) having a plurality of nozzles (304) assembled over the length for injecting a controlled amount of effluent liquid onto a plurality of pans (401). The sliding arrangement (302) ensures that the effluent liquid is injected at varying heights or depths depending on the requirements. The plurality of nozzles (304) are customized according to a geometry of the plurality of pans (401) for maintaining an optimal air flow profile. In other words, the plurality of nozzles (304) ensures that air flows evenly and efficiently through the plurality of pans (401) which is crucial for evaporation process. Additionally, each stack of pans (401) receives the effluent liquid from the injection units (300) independently.

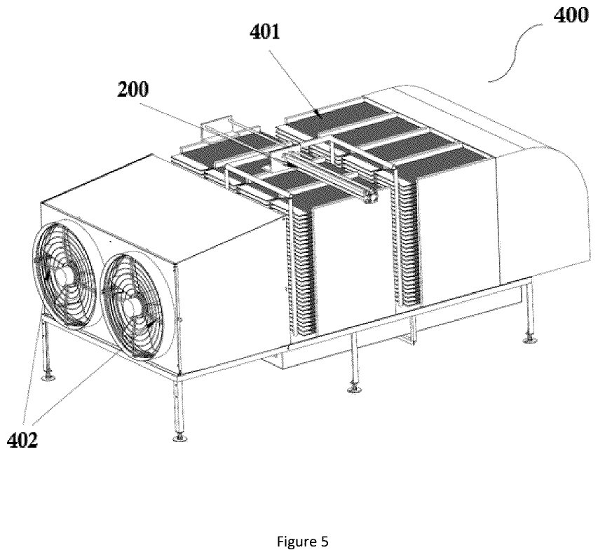

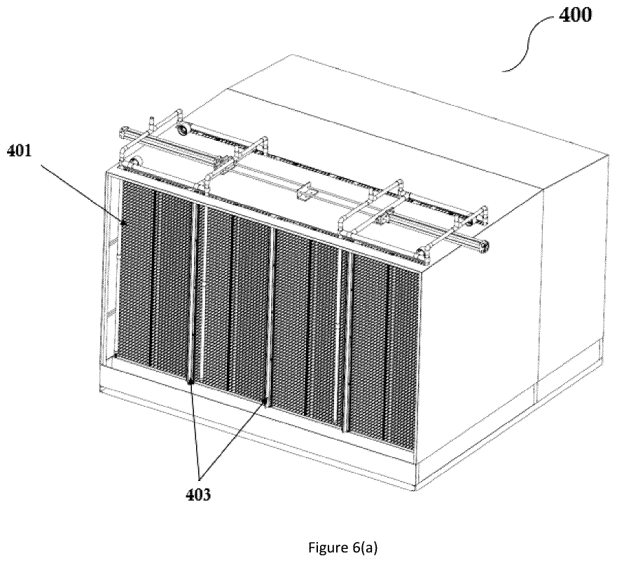

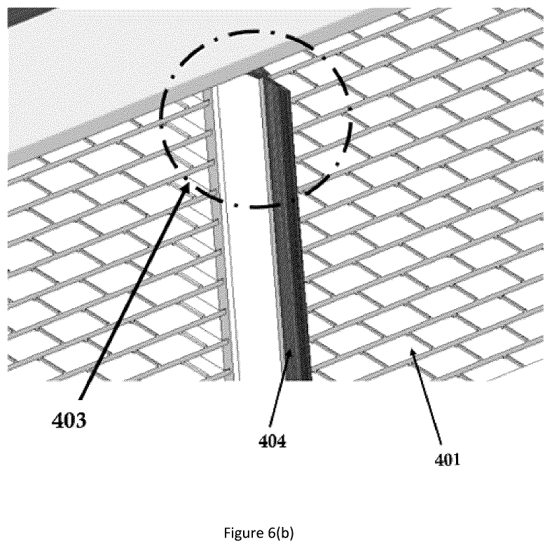

FIG. 5 is a perspective view of the evaporator unit (400) of the mobile injection unit based effluent treatment system (100) according to an embodiment of the present invention. Further, the evaporator unit (400) houses the plurality of pans (401) and the plurality of pans (401) are arranged over each other to receive the controlled amount of effluent provided by the injection unit (300). The evaporator unit (400) includes a plurality of pan end support structures (403) (as depicted in FIG. 6(a)) at a regular distance with a strip of brush (404) (as depicted in FIG. 6(b)) fitted on outer surface of each pan end support structure (403) for cleaning the plurality of nozzles (304) of the injecting pipes (303).

In an implementation, the brush (404) is preferably a nylon brush and are placed at a center distance of in range from 600 mm to 620 mm from each other. As the injecting unit (300) moves from one start point to an end point via the actuator, the brush (404) clean the nozzles (304) of the injecting pipes (303).

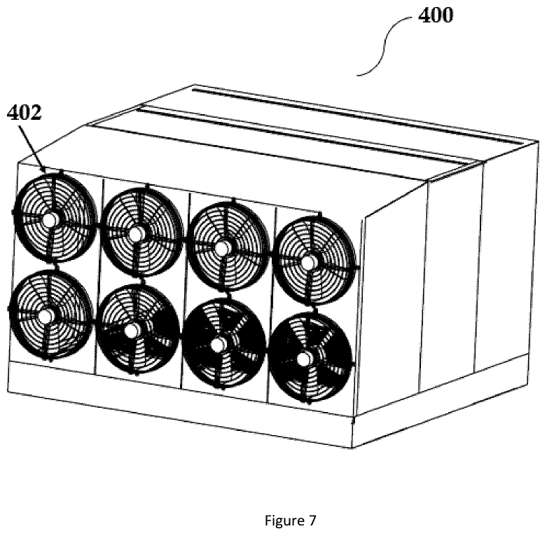

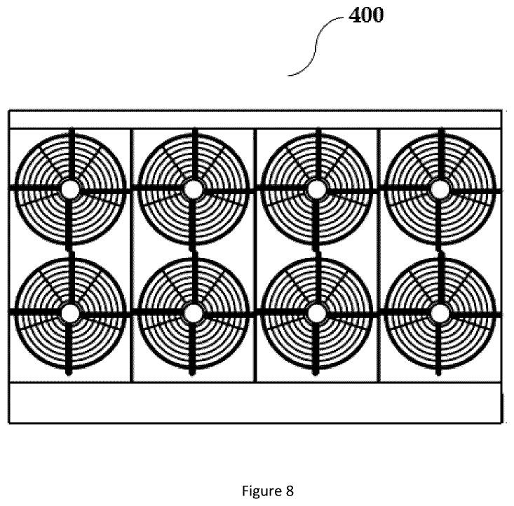

In an implementation, the evaporator unit (400) has a cuboidal structure which encompasses the plurality of pans (401) and the injection unit (300) is placed within the evaporator unit (400), as depicted in FIG. 7 and FIG. 8.

In another implementation, the evaporator unit (400) is fully assembled on a skid and has lower weight. The evaporator unit (400) is preferably 8 to 9 sq. mt for 2 to 5 m3 per day, and as the dimension of the evaporator unit (400) is less, therefore the evaporator unit (400) consumes less space. The evaporator unit (400) is easy to maintain and install.

The evaporator unit (400) is configured to heat the effluent present in the plurality of pans (401) that results in formation of vapor leaving behind a residue. The plurality of pans (401) have shape that include grill shape, circular shape, square shaped. The plurality of pans (401) hold the hot effluent. The pan (401) is made of material that include stainless steel, aluminum. Further, the dimension of pans (401) described herein are not limited to any specific measurements. The scope of present invention may include various sizes of the pans (401). The dimensions and placement of pans (401) may be adjusted or varied without deviating from the intended scope of the present invention.

The evaporator unit (400) includes a fan assembly (402) (as depicted in FIG. 7 and FIG. 8) for providing a direct and balanced airflow onto the plurality of pans (401) for spreading the effluent liquid uniformly and said evaporator unit (400) is configured to heat the effluent present in the plurality of pans (401) that results in formation of vapor leaving behind the residue. In an implementation, the fan assembly (402) acts as vents for mixing fresh air with humid air present in the evaporator unit (400). Also, the speed of fan assembly (402) is precisely controlled for optimizing the energy consumption and minimize droplet egress.

The fan assembly (402) maintains the airflow in different directions such as parallel flow direction, crossflow direction, counter-flow direction. In the parallel flow direction, the air flows in a direction of the flow of the effluent liquid in the plurality of pans (401), while in counter-flow direction, the air flows in a direction opposite to the flow of the effluent liquid in the plurality of pans (401). Further, in the crossflow direction, if the air flow is in X-plane then the direction of the flow of the effluent liquid is in Y-plane or vice versa.

The evaporator unit (400) include a heat source which heats the effluent present in the plurality of pans (401). The heat exchanger include a shell-and-tube heat exchanger or a plate heat exchanger. The evaporator (102) further include a vapor separator that is configured to separate the vapor (i.e. humidified air) from the effluent residue after completion of the evaporation process.

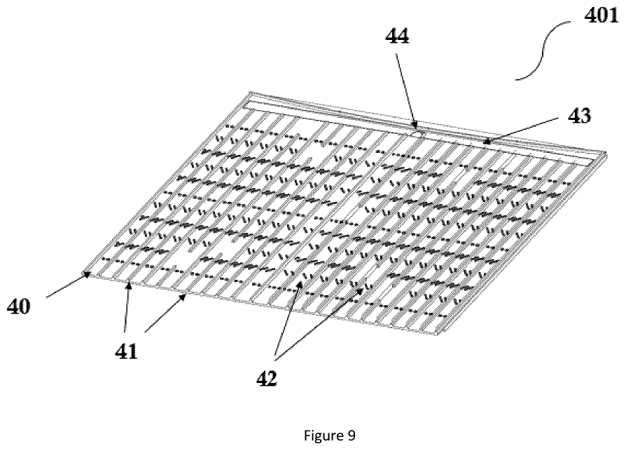

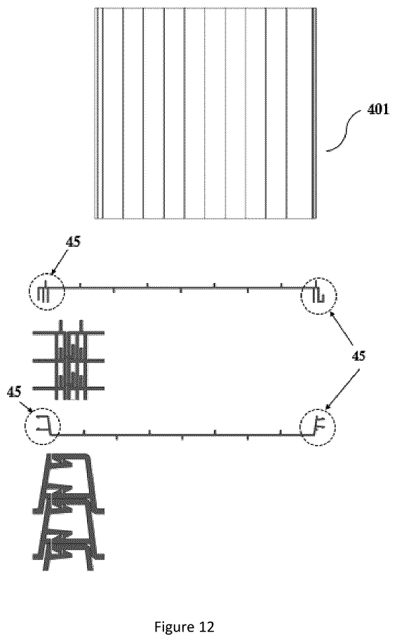

FIG. 9 is a perspective view of a pan of the mobile injection unit based effluent treatment system (100) according to an embodiment of the present invention. Further, the plurality of pans (401) have a base layer (40), a rib structure, a set of extended grooves (302) (depicted in FIG. 12) through which the plurality of pans (401) are arranged over each other in both horizontal direction and vertical direction and the rib structure on the base layer (40) ensures uniform distribution of the effluent liquid and also reduces splashing of the effluent liquid.

In an implementation, the each pan (401) of the plurality of pans (401) has the rib structure including a plurality of continuous and discontinuous elongated protrusions (41) and slanting patterns/zig-zag patterns (42) between the elongated protrusions (41) to minimize splashing of the effluent liquid and a basin structure (43) with a hole (44) to channelize treated water and eliminate the waterfall issue with the effluent liquid. The rib structure are thin extrusions which reduces the weight of the each pan (401). The plurality of pans (401) have the ability to assemble surface modularity in length wire direction and breadth wise direction, and reduces air resistance.

For example, the pan (401) is prepared by using a polyamide 6 (PA6) 10% MF black sheet (0181) and the pan has a rib thickness, a rib draft angle, a rib height, a sheet base thickness, Plastic Strain Ratio (R) in desired range, and the flatness of the surface is preferably 0.1 mm.

For example, the plurality of pans (401) have dimensions 600×600 mm, with thickness of rib in range from 1 to 1.6 mm with rib draft angle in range from 0.3 to 0.6 and a rib height of 4 to 4.6 mm and thickness of the base layer is in range from 2 mm to 3 mm and flatness of the surface of each pan is 0.1 mm.

Further, the strategic placement of the elongated protrusions (41) controls the flow of liquid, thereby ensuring that the effluent liquid spreads evenly over the surface and does not splash out. Furthermore, the hole (44) ensures that the effluent liquid is efficiently removed from the pan (401) once the treatment is complete thereby preventing any pooling or overflow. Additionally, the plurality of pans (401) eliminates the piping structure and the connectors and other leakage points that ultimately simplifies the installation of the plurality of pans (401).

The plurality of pans (401) are light weight and eliminated the splash of the effluent liquid or spilling of the effluent liquid from the plurality of pans (401).

The strategic placement of the rib structure on each pan (401) is not limited to any specific configuration or arrangement and include other structure, such as varying shapes, orientations or additional flow control patterns that effectively minimize splashing and ensuring uniform distribution of the effluent liquid for improved treatment efficiency.

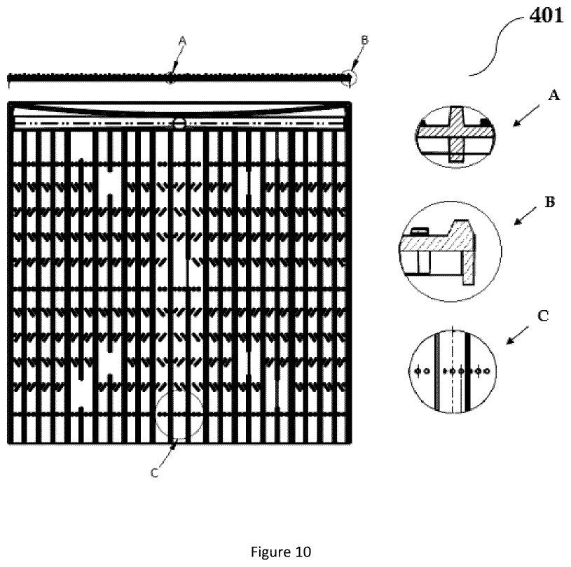

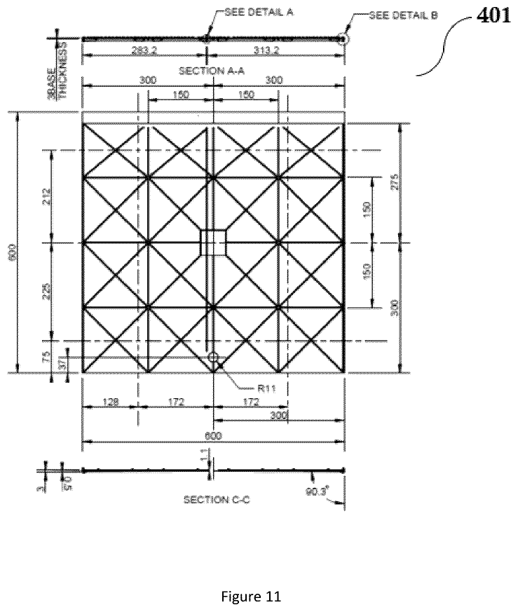

FIG. 10 is a top view of a pan (401) of the mobile injection unit based effluent treatment system (100) according to an embodiment of the present invention. Further, in FIG. 10, a feature encircled at center of the pan (401) in horizontal view of the pan (401) is labeled as A and a feature encircled at the corner of the pan (401) is designated as B and a feature encircled at the surface view is depicted as C. Further, a schematic view of the pan (401) is depicted in FIG. 11.

Further, the set of extended grooves (45) (depicted in FIG. 12) are located the ends of the pan structure. The set of extended grooves (45) are preferably in inverted U-shape or in channel shape for connecting the plurality of pans over each other in both horizontal direction and vertical direction. In an implementation, the set of extended grooves (45) are oriented vertically at the ends of the horizontal pan sides. Moreover, the structure of set of extended grooves (45) interlock with a corresponding groove (302) of another pan that allows for a snap-fit connection. Further, the set of extended grooves (45) facilitates the connection of plurality of pans side-by-side or end-to end.

### Example 1

### Use Case Scenario

The present invention provides mobile injection unit based effluent treatment system (100). For example, the present invention is applicable in manufacturing industries which produces waste water or effluent. The effluent is stored in a reservoir or tank, further which a help of pump and a pipe assembly, the effluent is transferred to the injection unit (300) of the system. The injection unit (300) introduces a precise amount of effluent to the plurality of pans. For instance, the injection unit (300) may inject 50 liters of hot effluent at 50 degree every 4 hours.

Thereafter, the effluent is distributed over each pan (401), the high surface area of the pan (401) facilitates the rapid evaporation. The evaporation process generates vapor and leave behind the cold unevaporated effluent which is collected and later recirculated and transferred to the evaporator (400) or treated separately. For instance, if 50 liters of effluent is processed, then 40 liters is evaporated and 10 liters is left as cold unevaporated effluent recirculated for further treatment.

After condensing, the vapors are then transferred from the evaporator to the condenser unit (500). The condenser unit (500) cools the vapor causing the vapors to condense back into liquid form, which results in treated water which is free from contaminants present in the effluent in the first tank. For instance, 40 liters of the effluent that was evaporated condenses into 30% of the treated water. The treated water is stored in the second tank (600).

Further, in the docking station where the nozzles of the injection pipes are easily cleaned. This ensures the regular checkup of the system and prevents any blockages or obstructions that impede the injection process. Moreover, in situations where the injection tube becomes clogged or damaged due to highly saline brines, a plug-and-play replacement mechanism is employed. This allows for easy replacement of the tube without complex procedures or significant downtime, ensuring uninterrupted operation of the effluent treatment system.

Therefore, the present invention provides a mobile injection unit based effluent treatment device and system that utilizes a controlled and efficient mechanism of distributing the effluent liquid onto the pans and facilitates easy cleaning and maintenance of the injection ports and offers a convenient replacement option for saline brine-related issues.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principle of the invention and its practical application to enable one skilled in the art to utilize the invention in various embodiments and with various modifications as are suited to the particular use contemplated.

1. A mobile injection unit based effluent treatment system (100), comprising:
a first tank (200) for storing an effluent liquid;
an injection unit (300);
an evaporator unit (400);
a condenser unit (500); and
a second tank (600) for receiving a treated water;
wherein:
said injection unit (300) includes two injecting pipes (303) conjoined to a common effluent input (305) and assembled with a sliding arrangement (302) and fitted over a frame (301) of evaporator unit (400) with each injecting pipe (303) having a plurality of nozzles (304) assembled over length for injecting a controlled amount of effluent liquid onto a plurality of pans (401);
said evaporator unit (400) houses the plurality of pans (401) arranged over each other to receive the controlled amount of effluent liquid and said evaporator unit (400) includes a plurality of pan end support structures (403) at a regular distance with a strip of brush (404) fitted on outer surface of each pan end support structure (403) for cleaning the plurality of nozzles (304) of the injecting pipes (303);
said evaporator unit (400) includes a fan assembly (402) for providing a direct and balanced airflow onto the plurality of pans for spreading the effluent liquid uniformly and said evaporator unit (400) is configured to heat the effluent present in the plurality of pans (401) that results in formation of vapor leaving behind a residue;
said plurality of pans (401) have a base layer (40), a rib structure, a set of extended grooves (45) through which the plurality of pans (401) are arranged over each other in both horizontal direction and vertical direction and the rib structure on the base layer (40) ensures uniform distribution of the effluent liquid and also reduces splashing of the effluent liquid; and
said condenser unit (500) receives the vapor from the evaporator unit (400) and condenses the vapor into the treated water.

2. The mobile injection unit based effluent treatment system (100) as claimed in claim 1, wherein said injection unit (300) withdraws the effluent liquid from the first tank (200) via a pump and pipe assembly.

3. The mobile injection unit based effluent treatment system (100) as claimed in claim 1, wherein said injection unit (300) include a pump for precise control over the dispensing of the effluent liquid onto the plurality of pans (401).

4. The mobile injection unit based effluent treatment system (100) as claimed in claim 1, wherein said common effluent input (305) is a T pipe connector further connecting the injecting lines (303) through a pair of elbow connector (306).

5. The mobile injection unit based effluent treatment system (100) as claimed in claim 1, wherein said injection unit (300) is additionally connected with a docking station and the docking station is configured to clean the plurality of nozzles (304).

6. The mobile injection unit based effluent treatment system (100) as claimed in claim 1, wherein said sliding arrangement (302) include telescopic arrangement, guide rails, hydraulic or pneumatic arrangements and motorized actuators.

7. The mobile injection unit based effluent treatment system (100) as claimed in claim 1, wherein said evaporator unit (400) include a heat source which heats the effluent present in the plurality of pans (401).

8. The mobile injection unit based effluent treatment system (100) as claimed in claim 1, wherein said evaporator unit (400) has a cuboidal structure which encompasses the plurality of pans (401) and the injection unit (300) is placed within the evaporator unit (400).

9. The mobile injection unit based effluent treatment system (100) as claimed in claim 1, wherein said plurality of pans (401) have shape that include grill shape, circular shape, square shape.

10. The mobile injection unit based effluent treatment system (100) as claimed in claim 1, wherein each pan of said plurality of pans (401) has the rib structure including a plurality of continuous and discontinuous elongated protrusions (41) and slanting patterns/zig-zag patterns (42) between the elongated protrusions (41) to minimize splashing of the effluent liquid and a basin structure (43) with a hole (44) to channelize treated water.

11. The mobile injection unit based effluent treatment system (100) as claimed in claim 1, wherein said fan assembly (402) acts as vents for mixing fresh air with humid air present in the evaporator unit (400).

12. The mobile injection unit based effluent treatment system (100) as claimed in claim 1, wherein said fan assembly (402) provides the airflow in at least one of a direction of the flow of the effluent liquid in the plurality of pans (401), opposite to the direction of the flow of the effluent liquid in the plurality of pans (401) and in a crossflow direction.

13. The mobile injection unit based effluent treatment system (100) as claimed in claim 1, wherein said set of extended grooves (45) facilitates the connection of plurality of pans side-by-side or end-to end.

14. The mobile injection unit based effluent treatment system (100) as claimed in claim 1, wherein said set of extended grooves (45) are preferably in inverted U-shape or in channel shape for connecting the plurality of pans over each other in both the horizontal direction and the vertical direction.

15. The mobile injection unit based effluent treatment system (100) as claimed in claim 1, wherein said mobile injection unit based effluent treatment system (100) is remotely controlled via a controller module for optimizing the evaporation of the effluent liquid.
